(19) United States
(12) Patent Application Publication
(10) Pub. No.: US 2017/0195774 A1
(43) Pub. Date: Jul. 6, 2017

(54) Dual Use Headphone Case with Component

(71) Applicants: Terrence Archer Brown, Laurel, MD (US); Brandon Archer Brown, Laurel, MD (US)

(72) Inventors: Terrence Archer Brown, Laurel, MD (US); Brandon Archer Brown, Laurel, MD (US)

(21) Appl. No.: 15/263,757

(22) Filed: Sep. 13, 2016

Related U.S. Application Data
(60) Provisional application No. 62/274,413, filed on Jan. 4, 2016.

(51) Int. Cl. H04R 1/10; A45C 13/10; A45C 11/24

(52) U.S. Cl. CPC H04R 1/1058; A45C 11/24; A45C 13/10; H04R 1/1008

(57) ABSTRACT

A headphone device case, in particular, a dual use case that can be used as both a standard headphone case and a component for personalization of the headphone casing.

### CROSS REFERENCE TO RELATED PRIOR PUBLICATION DATA

This application claims the benefit of provisional patent applications Ser. No. 62/274,413, filed Jan. 4, 2016 by the present inventor(s).

BACKGROUND - PRIOR ART

| PAT. NO. | PUBLICATION DATE | APP OR PATENTEE |
|---|---|---|
| D620,256 | Jul. 27, 2010 | Fujimura, et al. |
| D620,257 | Jul. 27, 2010 | Fujimura, et al. |
| D705,532 | May 27, 2014 | Kolton |
| 8,590,703 | Nov. 26, 2013 | Tierney, et al. |
| 9,008,346 | Apr. 14, 2015 | Kolton |
| 9,210,495 | Dec. 8, 2015 | Akino |
| 9,432,767 | Aug. 30, 2016 | Hata, et al. |
| 9,445,184 | Sep. 13, 2016 | Ring |

### FIELD OF THE INVENTION

This invention relates to a headphone device case, in particular, a dual use case that can be used as both a standard headphone case and a component for personalization of the headphone casing.

### BACKGROUND OF THE INVENTION

Originally headphones were designed for stereo use in music recording studios or the home. Over time, headphones begun to be used in a portable manner, with the invention of the cassette and CD/DVD players for use outside the home. Until recently, the headphone has been used for phones with increasing numbers thru the use of cellular communications, Bluetooth technology and the capability of listening to music on your phone. With this increased usage outside the home, the headphone became an extension of a person's distinct style.

While advancements in the headphone technology have been made, the prior art are not without fault and focus on making headphones different in terms of design (for example, US D620,256, D620,257 and D705,532) or focus on sound or acoustics (for example, U.S. Pat. Nos. 9,210,495 and 9,445,184). Thus, there still exists a need to provide a dual use headphone case that can both protect their headphones and that can be customized in a stylish manner, commonly known as “personalization” use.

### SUMMARY

The present invention is directed to a dual use headphone protective case that can be used as a standard headphone and a component for stylish personalization of the headphone casing. The dual use headphone case is provided for use with protection of the headphone device and for use customizing your device in a stylish manner, commonly known as “personalization” use.

It is an object of the present invention to provide a dual use headphone protective case that can be used as a standard headphone case. In a particular embodiment, the headphone case can form an outer lip that extends up above the top surface of the headphone device resulting in a protective rim.

It is an object of the present invention to provide a shape indentation for the headphone case that can be used to provide personalization for brand identification. In a particular embodiment, the headphone case shape indentation can take the form of a circular shape and a corresponding component can be guided within the indentation and connected in place via a magnetic connection.

It is an object of the present invention to provide a corresponding component for the headphone shape indentation that can be interchangeable for brand identification. In a particular embodiment, the component can take the same shape of the corresponding shape indentation for the headphone case. This component can be square in shape form and connected in place via a magnetic connection with personalization thru a brand identification, like displaying a sports team, music group, a flag or company logo and switched interchangeably on the headphone case, to not have to purchase multiple cases.

The headphone protective case itself may be made of any suitable material for protecting the device. In a particular embodiment, the headphone case can be made of different materials, including silicone, rubber, carbon fiber, plastic or various synthetics. The headphone shape component itself may be made of any suitable material for fastening the component to the headphone device. In a particular embodiment, the headphone component fasteners can be made of magnets, Velcro, Dual Lock, Xolok or various type of snaps.

Features and advantages are described below with reference to the drawings, and the preceding description which are intended to illustrate but not meant to limit the scope of the invention. Furthermore, the summary of the present invention is neither intended nor should it be construed as being representative of the full extent and scope of the present invention. No limitation regarding the scope of the present invention is intended to either the inclusion or non-inclusion of elements, components, etc. in this summary of the invention. Additional aspects of the present invention will become more readily apparent from the detailed description, particularly when taken together with the drawings.

### BRIEF DESCRIPTION OF THE DRAWINGS

FIG. 1—is the outside view of the housing of the headphone device case, of the present invention.

FIG. 1A—is the close up of the outside view of the housing of the headphone device case, showing the center area of the housing where the component is displayed, of the present invention.

FIG. 2—is the inside view of the housing of the headphone device case, of the present invention.

FIG. 3—is the top view of the housing of the headphone device case, of the present invention.

FIG. 3A—is the close up of the top inside view of the housing of the headphone device case, showing the neck area of the headphone device coming down over the top of the housing of the headphone device case, of the present invention.

FIG. 4—is the bottom view of the housing of the headphone device case, of the present invention.

FIG. 5—is the side view of the housing of the headphone device case, of the present invention.

FIG. 5A—is the close up of the side view of the housing of the headphone device case, showing the guide part within the shape indentation of the headphone device case, of the present invention.

FIG. 5B—is the close up of the isometric view of the housing of the headphone device case, showing the headphone case and the connection with the headphone device where the fit is tight to provide protection, of the present invention.

FIG. 6—is the isometric view of the housing of the headphone device case, of the present invention.

### DETAILED DESCRIPTION

Before explaining the present invention in a detailed manner, it is to be understood that the invention is not limited to the particular embodiments and that it can be practiced or carried out in various ways.

The dual use headphone case is provided for use with protection of the headphone device and for use customizing your device in a stylish manner, commonly known as “personalization” use. Although the headphone case of the present invention is depicted with a circular shape form, it is also possible for the cases to have other suitable shapes, for example, oval, polygon or triangle.

The headphone case shape indentations and components of the present invention are depicted with a circular shape form, it is also possible for the cases to have other suitable shapes, for example, square, oval, rectangular or triangle. In an alternative embodiment, the headphone case may have a circular shape, whereas the indentation and components may have a square shape.

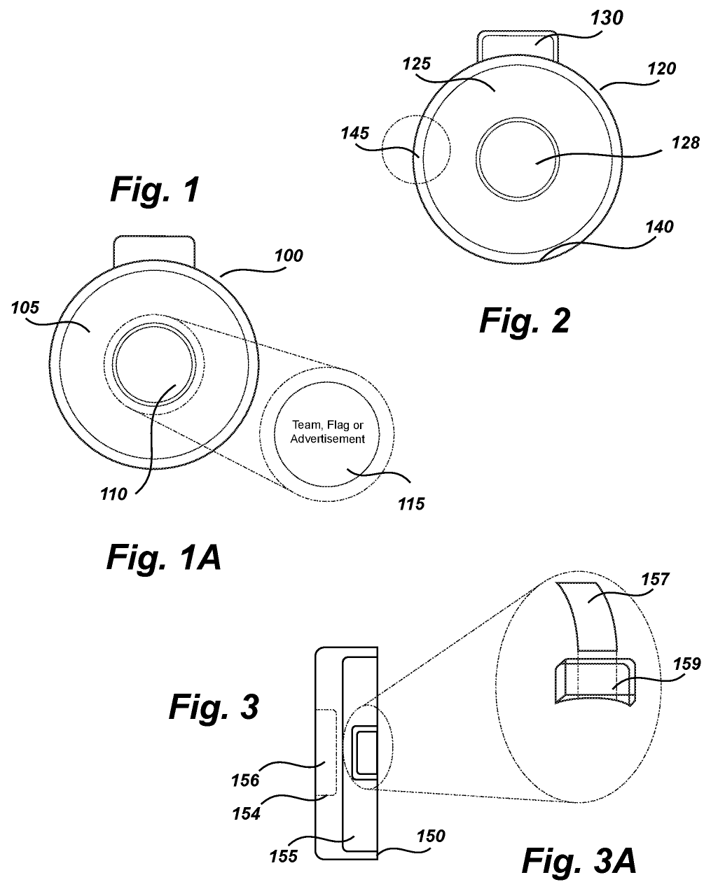

FIG. 1—is the outside front view housing of the headphone device case 100, which shows the outside view of the case, with the headphone device 105 shown inside the cavity of the case, so that the headphone case appears to fit within the housing of the device. The case shows the shape indentation 110 in the center of the housing, with the indentation not visible. The headphone device is shown and not a part of this present invention. The present invention is not limited to its use with a particular headphone device. The present invention can be practiced or carried out with various headphones, with different dimensions, shapes and thicknesses. The present invention can be practiced or carried out with different shape indentation placements to accommodate different headphones, with different dimensions, shapes and thicknesses.

FIG. 1A—is the close up of the outside front view of the housing of the headphone device case 100, which shows the outside view of the case, so that the center area of the housing where the component 115 is displayed in greater detail in certain embodiment. In particular embodiment, the component shows how a personalization area can be prepared or carried out on the outside wall for displaying a brand, company name, sports team, music group, flag, commercial symbol, trade logo, label, emblem, insignia, copyrighted item, and/or personage. The present invention is not limited to its component and can be practiced or carried out with different dimensions, shapes and placements on the case.

FIG. 2—is the inside view of the housing of the headphone device case 120, which shows the inside view of the case, with the headphone device 125 shown inside the cavity of the case, so that the headphone case appears to fit within the housing of the device. The case shows the shape indentation 128 in the center of the housing, with the indentation visible. The case shows the neck shape indentation 130, forming a u-shaped (or arc) are in the center of the neck of the housing, which surrounds the neck of the headphone device. The neck indentation can be applied to create cases to support various headphone cases, with different dimensions, shapes and thicknesses. The case shows the outer rim 140 where the housing of the case connection 145 to the device 125. In this particular embodiment, this connection around the outer rim is “tight” in order to protect and secure the case.

The headphone device is shown and not a part of this present invention. The present invention is not limited to its use with a particular headphone device. The present invention can be practiced or carried out in various headphones, with different dimensions, shapes and thicknesses.

FIG. 3—is the outside top view of the housing of the headphone device case 150, which shows the outside view of the case, with the headphone device 155 shown inside the cavity of the case, so that the headphone case appears to fit within the housing of the device. The case shows the component 156 sitting within the shape indentation 154 in the front center of the housing, with the component shown in hidden lines. The headphone device is shown and not a part of this present invention. The present invention is not limited to its use with a particular headphone device. The present invention can be practiced or carried out in various headphones, with different dimensions, shapes and thicknesses.

FIG. 3A—is the close up of the outside top inside view of the housing of the headphone device case 150, which shows the neck area 157 of the headphone device 155 and display how the neck area descends over the neck shape indentation 159 at the top of the housing of the headphone device case in greater detail. The present invention is not limited to its neck shape and can have different dimensions and thicknesses.

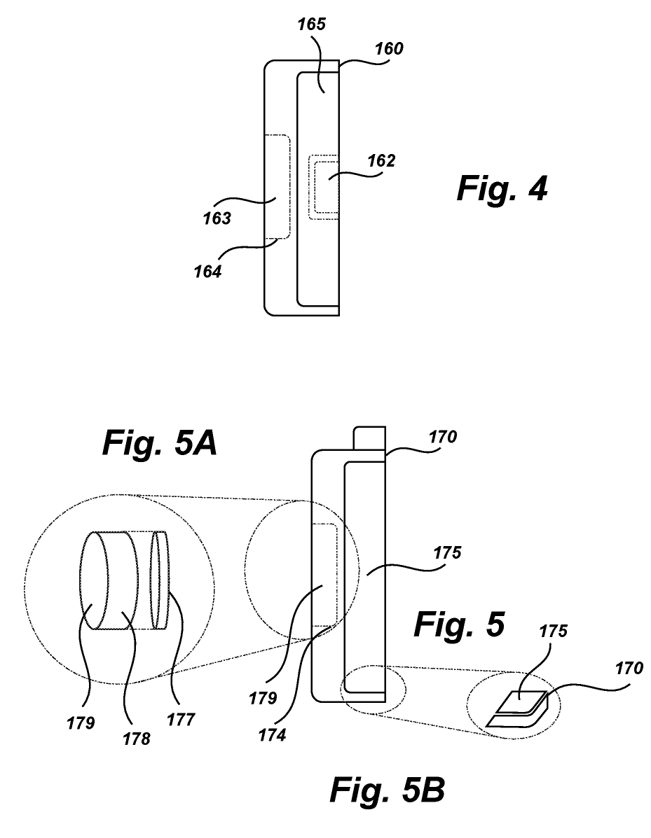

FIG. 4—is the outside bottom view of the housing of the headphone device case 160, which shows the outside view of the case, with the headphone device 165 shown inside the cavity of the case, so that the headphone case appears to fit within the housing of the device. The case shows the component 163 sitting within the shape indentation 164 in the front center of the housing, with the component shown in hidden lines. The case shows the neck shape indentation 162 of the headphone device in the back center of the housing, with the neck indentation shown in hidden lines. The headphone device is shown and not a part of this present invention. The present invention is not limited to its use with a particular headphone device. The present invention can be practiced or carried out in various headphones, with different dimensions, shapes and thicknesses.

FIG. 5—is the outside side view of the housing of the headphone device case 170, which shows the outside view of the case, with the headphone device 175 shown inside the cavity of the case, so that the headphone case appears to fit within the housing of the device. The case shows the component 179 sitting within the shape indentation 174 in the front center of the housing, with the component shown in hidden lines. The headphone device is shown and not a part of this present invention. The present invention is not limited to its use with a particular headphone device. The shape indentation can be practiced or carried out, with different dimensions, shapes and thicknesses.

FIG. 5A—is the close up of the side view of the guide part of the headphone device case 170, within the shape indentation 174, where the fasteners are broken up into two mating connector parts: a male connector 178 and a female connector 177. In addition, the guide part provided to and projected from the case and is configured to guide the component 179, which is to be connected to said casing, to a connecting position. In a particular embodiment, the connectors (male or female) can be made of magnets, Velcro, Dual Lock, Xolok and/or closure elements. In particular embodiment, the component can be prepared or carried out on the outside wall for displaying a brand, company name, sports team, music group, flag, commercial symbol, trade logo, label, emblem, insignia, copyrighted item, and/or personage. The present invention is not limited to its shape component that can be practiced or carried out with different component dimensions and shapes. The present invention can be practiced or carried out with different shape indentation placements to accommodate different headphones, with different dimensions, shapes and thicknesses.

FIG. 5B—is the close up of the isometric view of the housing of the headphone device case 170 outer rim, showing both the side and front view of the headphone case where the bottom of the housing connects with the headphone device 175 where the fit is tight to provide protection. In this particular embodiment, this connection around the outer rim is tight in order to protect and secure the case. The headphone device is shown and not a part of this present invention. The present invention is not limited to its use with a particular headphone device. The present invention can be practiced or carried out in various headphones, with different dimensions, shapes and thicknesses.

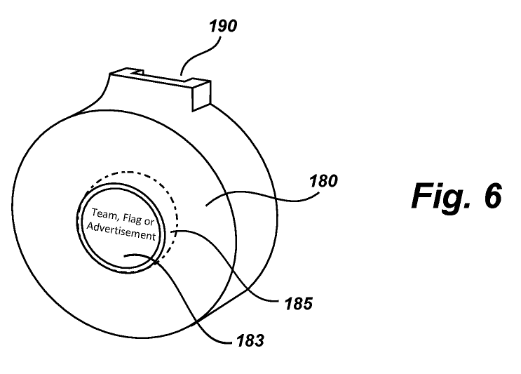

FIG. 6—is the isometric view of the housing of the headphone device case 180, which shows the outside view of the case, so that the headphone case appears in a three-dimensional view, so that the center area of the housing where the component 115 is displayed in certain embodiment. The case shows the shape indentation 185 in the center of the housing shown in hidden lines, with the indentation is visible. The case shows the neck shape indentation 190, forming a u-shaped (or arc) are in the center of the neck of the housing. In particular embodiment, the component shows how a personalization area can be prepared or carried out on the outside wall for displaying a brand, company name, sports team, music group, flag, commercial symbol, trade logo, label, emblem, insignia, copyrighted item, and/or personage. The present invention is not limited to its component and can be practiced or carried out with different dimensions, shapes and placements on the case. The present invention is not limited to its use with a particular headphone device. The present invention can be practiced or carried out in various headphones, with different dimensions, shapes and thicknesses.

We claim:

1. A casing for a headphone device equipped with a component comprising:
a) a housing accommodating a formed shaped indentation within the said casing;
b) a component provided to the housing of the said casing within the shaped indentation,
c) a guide part including a plurality of fasteners provided to and projected from said casing within the shaped indentation and configured to guide the component, which is to be connected to said casing, to a connecting position.

2. The headphone device case of claim 1, wherein the said housing is comprised of different materials.

3. The headphone device case of claim 1, wherein the said shaped indentation having formed recessed configurations.

4. The headphone device case of claim 1, wherein the said component is dimensioned and shaped corresponding to the formed recessed configuration.

5. The headphone device case of claim 1, wherein the said component contains a personalization area on an outside wall of the component for displaying a brand, company name, sports team, music group, flag, commercial symbol, trade logo, label, emblem, insignia, copyrighted item, and/or personage.

6. The headphone device case of claim 1, wherein the said guide part is comprised of a plurality of fasteners, comprised of both male and female connectors connecting the said component to the said case.

7. The headphone device case of claim 1, wherein the said fasteners comprise magnets, Velcro, Dual Lock, Xolok and/or closure elements.

8. The headphone device case of claim 1, wherein the said fasteners connect the said component to the said case, enabling the said component to be switched interchangeably on the said case in the said guide part in the shaped recessed indentation on the said case.
